(19) United States
(12) Patent Application Publication
(10) Pub. No.: US 2026/0236138 A1
(43) Pub. Date: Aug. 13, 2026

(54) IN-DOCUMENT APPLICATIONS FOR ELECTRONIC DOCUMENTS

(71) Applicant: FACTIFY TECHNOLOGIES INC., Dover, DE (US)

(72) Inventors: Matan Gavish, Givat Ada (IL); Gil Asher, Binyamina (IL); Royi Noiman, Tel Aviv (IL); Rinat Freida Sorkin, Karmiel (IL); Orit Balicer Tsur, Ramat Gan (IL); Tal Koelewyn, Modi'in (IL)

(21) Appl. No.: 19/640,239

(22) Filed: Apr. 6, 2026

Related U.S. Application Data
(63) Continuation of application No. PCT/US2025/034276, filed on Jun. 18, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.
(60) Provisional application No. 64/002,016, filed on Mar. 10, 2026.
(60) Provisional application No. 64/010,751, filed on Mar. 19, 2026.

(51) Int. Cl. G06F 3/04817; G06F 16/93; G06N 20/00

(52) U.S. Cl. CPC G06F 3/04817; G06F 16/93; G06N 20/00

(57) ABSTRACT

The aspects described herein pertain at least to a method for receiving, at an electronic document, a request to initiate an in-document application, initiating, by execution of the electronic document, the in-document application, and facilitating, by the execution of the electronic document, an interaction between the in-document application and the electronic document.

### PRIORITY CLAIMS TO RELATED APPLICATIONS

This application is a continuation application of and claims priority to International Patent Application No. PCT/US25/34276 filed Jun. 18, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, U.S. Provisional Patent Application 64/002,016, filed Mar. 10, 2026, and U.S. Provisional Patent Application 64/010,751, filed Mar. 19, 2026, each of which are incorporated herein in their entirety by these references.

### BACKGROUND

Traditional systems for revising, circulating, and generally interacting with electronic documents rely heavily on modifying documents separately, saving these documents in various locations, and sharing multiple versions of these documents with various users via, e.g., email applications, file sharing servers, and so forth. Further, current digital documents include a number of plug-ins and various supplemental software applications that enable inclusion of content within these documents. Such supplemental software applications, however, are third party proprietary software applications that are different from the underlying document software that operates the digital documents. As such, the supplemental software applications and the underlying software must be interoperable.

Maintaining such interoperability requires consistent software updates, which can be computationally inefficient and resource intensive. These software updates also result in interruptions to the use of the digital documents and create errors in operation and execution of the underlying document software, adversely affecting user experience. Further, in many instances, using a proprietary third party software application requires users to leave the environment of the digital document and interact with an aspect of the third party software application to perform a particular task while temporarily relinquishing access to the digital document. Moreover, the third party software applications are highly specialized and lack the ability to dynamically adapt to the specialized document interaction behaviors of various users.

### SUMMARY

In some aspects, the techniques described herein relate to a computer-implemented method comprising: receiving, at an electronic document, a request to initiate an in-document application, initiating, by execution of the electronic document, the in-document application, and facilitating, by the execution of the electronic document, an interaction between the in-document application and the electronic document.

In some aspects, the techniques described herein relate to a system comprising: at least one physical processor, physical memory comprising computer-executable instructions that, when executed by the physical processor, cause the physical processor to: receive, at an electronic document, a request to initiate an in-document application, initiate, by the execution of the electronic document, the in-document application, and facilitate, by the execution of the electronic document, an interaction between the in-document application and the electronic document.

In some aspects, the techniques described herein relate to non-transitory computer-readable medium comprising computer-executable instructions that, when executed by at least one of one or more processors of a computing device, cause the computing device to receive, at an electronic document, a request to initiate an in-document application, initiate, by the execution of the electronic document, the in-document application, and facilitate, by the execution of the electronic document, an interaction between the in-document application and the electronic document.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 depicts a structure of an electronic document;

FIG. 2 illustrates a system for managing electronic documents as smart digital objects;

FIG. 3 illustrates a flowchart of a method involving implementing an in-document application from within an environment of an electronic document;

FIG. 4 illustrates an electronic document as stored in a nonshared globally addressable location in memory of a device;

FIG. 5A illustrates an example use case of an owner of an electronic document initiating an in-document application for completing a document approval process;

FIG. 5B illustrates the electronic document displaying a legal task notification responsive to the initiation of a document approval process;

FIG. 5C illustrates the electronic document 102 displaying a marketing task notification responsive to initiating the document approval process as described above and illustrated in FIG. 5A.

FIG. 6 illustrates an example digital content box that lists notifications of the completion of tasks completed by various users;

FIG. 7 illustrates a symbol of an in-document application representing completion of a document approval process;

FIG. 8 illustrates the use of an interactive GUI of an in-document application to distribute the example electronic document to a number of users and obtaining data of the users' interaction with the document;

FIG. 9 illustrates modifying the example electronic document;

FIG. 10 illustrates a visual layout of an in-document application that includes multiple panels; and

FIG. 11 illustrates another visual layout of the in-document application that also includes multiple panels.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

Electronic documents, also referred to as digital documents, encompass any form of document stored or accessed using a computer or digital medium. Common formats for electronic documents include PS, PDF, and XPS, among others. These documents are represented digitally as files stored on local drives, shared networks, or cloud-based systems. However, traditional methods of managing electronic documents often result in a loss of control for individuals and entities. This loss of control occurs whether the documents are shared externally with third parties or kept internally within an organization.

For example, when a company hires a new employee and grants them access to proprietary information, the company effectively relinquishes control over that information, typically in the form of electronic documents such as PDFs, spreadsheets, word processing files, and forms. Instead of maintaining actual control, the company relies on pseudo-control mechanisms, such as policies, procedures, and legal agreements. If the employee leaves the company and improperly retains or uses these documents, the company must resort to enforcing employment agreements through the legal system. This may involve attempting to recover or destroy the documents or seeking damages for any harm caused by the former employee's misuse of the information.

Similar scenarios occur daily in commerce and other professional relationships. The proliferation of electronic documents creates a chaotic environment where control is tenuous at best. The primary safeguard against misuse is the legal system, which provides a mechanism for enforcing contractual obligations when improper activity has a significant impact. However, litigation is often expensive, uncertain, and disruptive, encouraging parties to comply with contractual obligations to avoid legal disputes.

For instance, in an unsuccessful M&A transaction, one party may inadvertently retain trade secrets from the other side after the deal falls apart. While retaining these documents may breach material erasure provisions of a non-disclosure agreement, the party is unlikely to share the trade secrets with outsiders due to ethical considerations and the fear of legal repercussions. This reliance on pseudo-control—where compliance is partial and breaches are minor enough to avoid litigation—represents the best outcome achievable under the current system.

In virtually every arms-length transaction, confidential information is shared with the expectation that the legal system and a general aversion to litigation will prevent significant misuse. Whether paying for a sandwich with a credit card, engaging in banking or investment activities, consulting with an attorney, completing a real estate transaction, or working with an accountant to prepare taxes, parties routinely share sensitive information and rely on pseudo-control mechanisms to protect it. This reliance on goodwill and the legal ecosystem underscores the limitations of the current system.

There is a clear need for a system that provides actual control over electronic documents, eliminating dependence on the goodwill of others and the costly, uncertain, and distracting process of legal enforcement. Such a system would ensure that document security and integrity are maintained without relying on external safeguards, enabling more efficient and reliable management of sensitive information in modern digital environments.

As stated, current digital documents include a number of plug-ins and various supplemental software applications that require interoperability with third party software applications separate and distinct from the underlying software application operating these documents. Further, as stated, maintaining interoperability requires consistent software updates that interrupt the documents' use and results in errors in the operation and execution of the underlying document software. Such issues adversely affect user interactions with these digital documents. Further, using third party software applications may require users to leave the immediate environment of the digital document in order to utilize the third party software plug-in, which results in temporarily relinquishing access to the document. Finally, current third party software applications lack the capability to track and analyze users' document interaction history and predict a likely next action of a user based on this history.

The systems and methods disclosed herein address one or more of the challenges identified above by introducing a transformative suite of in-document applications that are integrated as part of digital documents provisioned as digital infrastructure (i.e. self-determinative documents. From here on in the disclosure, an electronic document will be referenced interchangeably as either a self-determinative document, a digital document, a smart document, electronic document provisioned as digital infrastructure, or simply as the document. Further, in-document applications will be described in greater detail in this disclosure. In-document applications, as described herein, are operable based on execution of instructions of application programming interfaces (APIs) embedded as part of these digital documents. These applications are capable of tracking and analyzing users' document interaction patterns and presenting various files, in-document applications, and digital content based on these patterns. Additionally, all of these in-document applications are executed in and live within an environment of the digital documents and enable users to perform a wide variety of tasks associated with the document without leaving the respective environments of these documents.

Self-determinative documents may be designed to maintain control over their lifecycle, access, and interactions, reducing the reliance on pseudo-control mechanisms such as policies, procedures, and legal agreements. By embedding intelligence directly within the document, the embodiments of this disclosure may provide a robust framework for ensuring security, integrity, and compliance, even when documents are shared externally or distributed across various platforms. This embedded intelligence also accesses data related to various parts of these documents to generate a visual layout presentation framework that significantly simplifies the process of identifying a document of interest, thereby resolving the traditional deficiencies relating to document searching.

Further, traditional methods of managing electronic documents often result in a loss of control once the document is shared, as highlighted in the example of a company granting an employee access to proprietary information. The systems and methods disclosed herein may address this problem by provisioning documents with embedded intelligence, such as an integrated API or software chip, which allows the document to autonomously enforce access permissions and track interactions. For instance, a self-determinative document including sensitive company data can restrict access to authorized users only, even if the document is shared externally. If an employee leaves the company, the document can revoke their access in real-time, ensuring that proprietary information remains secure without requiring legal intervention.

In addition, self-determinative documents have one or more of a variety of attributes and advantages that enable them to address the drawbacks of traditional documents. These include dynamic access control, the ability to be a single source of truth, enhanced security and confidentiality, streamlined collaboration and compliance, universal accessibility, integrity and availability, true ownership, empowering ownership transitions, and enabling a universal frictionless system of record. The advantages of self-determinative documents are further improved when operating as part of and in collaboration with a document management hub. These include an improved visual layout frameworks for presenting document search results, advanced search result filtering, automatic and seamless content propagation, and efficient workflow management. These and other features and advantages enable a world that is transformed by self-determinative documents.

The transition to a world dominated by self-determinative documents marks a significant shift in how individuals and organizations interact with digital information. For example, the reliance on paper documents diminishes significantly in a self-determinative document world. Traditional paper-based workflows, such as printing, signing, and scanning, are replaced by digital processes that leverage embedded intelligence and biometric authentication. For instance, contracts and agreements can be signed electronically using facial recognition or fingerprint scans, eliminating the need for physical signatures. Self-determinative documents can autonomously verify the authenticity of these biometric inputs, ensuring that the signing process is secure and tamper-proof. This reduction in paper usage not only streamlines workflows but also contributes to environmental sustainability by minimizing waste and resource consumption.

One of the most noticeable changes may be the reduction in the use of traditional input methods, such as keyboards. Self-determinative documents, equipped with embedded intelligence and dynamic interfaces, allow users to interact with documents through voice commands, gestures, and AI-driven prompts. For example, instead of typing lengthy edits or comments, users can verbally instruct the document to make changes, with the embedded intelligence processing and executing these commands in real-time. This shift not only enhances efficiency but also makes document interaction more intuitive and accessible, particularly for individuals with physical limitations or those working in environments where traditional input devices are impractical.

As self-determinative documents become the standard, traditional signatures may increasingly be replaced by AI-driven and biometric interactions. Embedded intelligence within the document can analyze and authenticate biometric data, such as voice patterns, facial features, or fingerprints, to confirm user identity and authorize actions. AI further enhances this process by providing contextual insights and recommendations, such as suggesting edits, highlighting discrepancies, or automating repetitive tasks. For example, a self-determinative document used in a legal setting can flag clauses that require attention or suggest alternative language based on prior agreements. These advancements reduce reliance on manual processes and foster a more seamless and secure interaction with digital documents, paving the way for a future where document management is driven by intelligence and innovation.

In a post-PDF world dominated by self-determinative documents, the advantages extend to improving operational efficiency and reducing human error. For example, in industries such as healthcare, self-determinative documents can autonomously update patient records based on real-time inputs from medical devices or lab results. This eliminates the need for manual data entry, reducing errors and ensuring that healthcare providers have access to the most accurate and up-to-date information. Similarly, in logistics, self-determinative shipping manifests can dynamically adjust based on inventory changes or delivery schedules, streamlining operations and minimizing delays.

Another advantage is the ability to enforce granular access control and compliance across diverse environments. For instance, in financial services, self-determinative documents can restrict access to sensitive sections of a report based on user roles, such as allowing auditors to view transaction details while limiting access for junior staff. The embedded intelligence within the document ensures that compliance with regulatory requirements, such as GDPR or HIPAA, is maintained without the need for constant oversight. This capability is particularly valuable in industries where data security and privacy are critical.

Self-determinative documents also enhance collaboration by enabling real-time interaction among multiple users. For example, during the drafting of a legal contract, stakeholders can simultaneously view and comment on the document, with notes and access tracked and logged by the embedded intelligence.

The ability to integrate with artificial intelligence (AI) systems further amplifies the advantages of self-determinative documents. For example, in marketing, AI-driven self-determinative documents can analyze user engagement data to suggest improvements to campaign strategies. A marketing report may highlight trends in customer behavior or recommend adjustments to ad placements based on real-time analytics. In education, self-determinative documents can adapt their content based on student performance, providing personalized learning experiences that cater to individual needs.

Another transformative advantage is the ability to create tiered access systems that align with business models. For instance, a subscription-based service can use self-determinative documents to offer different levels of access to content based on subscription tiers. A basic subscriber may access summary reports, while premium subscribers can view detailed analytics and proprietary insights. This flexibility allows businesses to monetize their content effectively while maintaining control over its distribution.

Finally, self-determinative documents may contribute to building trust and transparency in digital interactions. By maintaining a single authoritative version and providing detailed audit trails, these documents ensure that all interactions are traceable and verifiable. For example, in supply chain management, self-determinative documents can track the provenance of goods, ensuring that stakeholders have confidence in the authenticity and quality of products. This capability is particularly valuable in industries such as pharmaceuticals or luxury goods, where trust and transparency are paramount.

In summary, the post-transition world of self-determinative documents offers a wide range of advantages, from operational efficiency and enhanced collaboration to improved security, personalization, and environmental sustainability. By leveraging embedded intelligence and dynamic capabilities, these documents transform the way individuals and organizations manage, interact with, and derive value from digital information.

The following detailed description provides an in-depth explanation of the systems, methods, and interfaces for smart documents. These smart documents are embedded with intelligence that enables them to autonomously manage their lifecycle, interactions, and security. This disclosure details the use of in-document applications, which may be utilized to perform various tasks associated with one or more electronic documents in a computationally efficient and user friendly manner. These applications enable users to perform various tasks without leaving the environment of the electronic document and provide them with a visual layout that is specific to the document interaction practices and patterns of these users. As such, users may be able to perform various tasks associated with these documents more efficiently.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

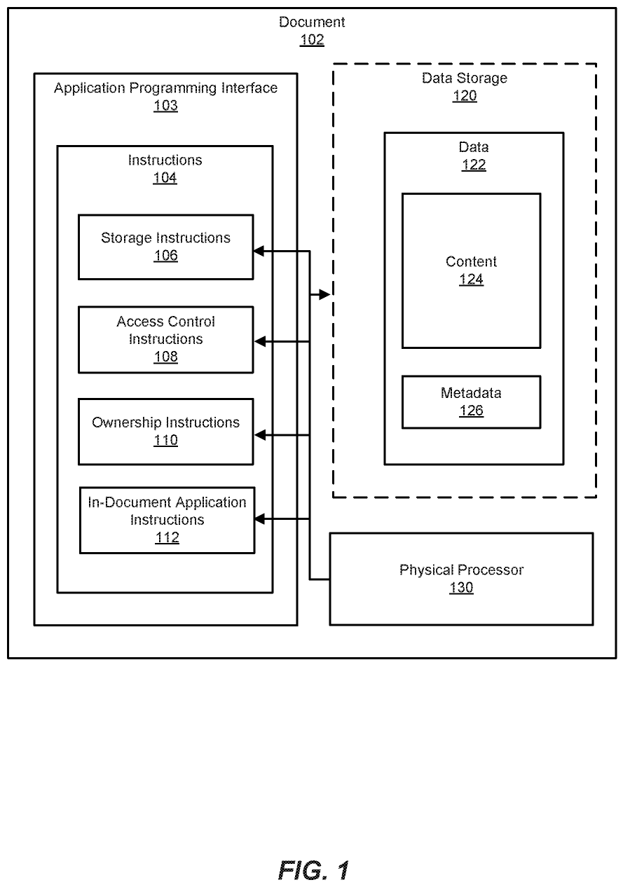

FIG. 1 depicts a structure of a self-determinative document. The self-determinative document 102 serves as digital infrastructure that integrates various interfaces and components of devices to manage various aspects of the document, e.g., accessing the document, editing the document, sharing the document, and so forth. Provisioned as digital infrastructure, the document 102 includes an application programming interface (API) 103 (referred to herein interchangeably as “API,” “application programming interface,” API 103) with instructions 104. The instructions 104 play an important role in the operation of the electronic document 102, namely providing the necessary connections between the document 102 and its various functionalities. These instructions 104 include the storage instructions 106, access control instructions 108, ownership instructions 110, and In-Document Application Instructions 112. Each set of instructions is responsible for a specific aspect of the document's functionality, ensuring that data is stored securely, access is controlled, ownership is maintained, and in-document application functionalities are made accessible to various users.

The storage instructions 106 are responsible for managing the storage of data within the document 102. The storage instructions 106 interact with the data storage 120 to ensure that data 122 is stored efficiently and securely. The storage instructions 106 facilitate the retrieval and updating of data 122, allowing the document 102 to maintain a single true copy and ensuring consistency across all accessed versions. This set of storage instructions 106 play an important role in the document's ability to provide dynamic content rendering and real-time updates.

In some examples, the data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata may include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata may indicate that a document is an NDA (Non-Disclosure Agreement), a marketing presentation, or a financial report. It may also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

The physical processor 130 is a hardware component that executes the instructions 104 embedded within the document 102. The physical processor 130 enables the document 102 to perform functions such as detecting signing actions, recording signatures, and managing the lifecycle of the document. This integration of hardware and software allows the document 102 to operate independently, adapting to various user environments and workflows.

An electronic document with embedded computer-executable code, which is also referred to herein as a smart electronic document, generally refers to a type of electronic document embedded with intelligence that enables it to autonomously monitor, record, and manage events associated with its lifecycle, access, and interactions. Unlike traditional documents, which depend on external systems or manual input to track changes and interactions, smart electronic documents are designed to independently identify and log activities such as access attempts, modifications, and interactions with other documents or systems.

The embedded intelligence within a smart electronic document allows it to maintain a detailed audit trail, offering insights into who accessed the document, when it was accessed, and what actions were performed. This capability is invaluable for ensuring compliance with regulatory requirements and organizational policies, as it provides a reliable and tamper-proof record of all document-related activities.

Smart electronic documents also enhance security by dynamically managing access permissions through mechanisms such as role-based access control, encryption, and multi-factor authentication. These documents ensure that only authorized users can view or modify their content. By transforming documents into active entities capable of self-monitoring and self-regulation, organizations can significantly reduce the risk of unauthorized access and data breaches while streamlining document management processes and maintaining data integrity. A smart electronic document is composed of code (i.e., intelligence), content, and metadata, which together enable its autonomous functionalities.

The attributes of a smart electronic document are multifaceted and address one or more of the limitations of traditional document management systems. For example, a smart electronic document is uniquely addressable, meaning it has a permanent and immutable identifier that distinguishes it from all other documents. This identifier ensures that the document can be reliably accessed and referenced, regardless of its location. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another attribute of a smart electronic document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes.

The creation of new versions is governed by strict rules and cryptographic mechanisms to ensure authenticity and prevent unauthorized modifications. When a user or system initiates a change, the smart electronic document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a smart electronic document is a foundational characteristic that ensures the integrity, reliability, and trustworthiness of the document throughout its lifecycle. This immutability is achieved through a combination of technical mechanisms and design principles, which are explained below.

The “content” of a smart electronic document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a smart electronic document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the smart electronic document does not alter the original content. Instead, it creates a new version of the document with its own unique identifier and cryptographic hash. The original version remains intact and accessible, ensuring that the history of the document is preserved. Each version of the document is uniquely addressable and linked to the previous versions, creating a hierarchical structure that allows users to trace the evolution of the document. This approach ensures that the original content is never overwritten or lost.

In some embodiments, the smart electronic document may leverage distributed ledger technology to ensure immutability. The content and its associated hash can be recorded on a distributed ledger, where each entry is cryptographically secured and immutable. This approach provides an additional layer of protection, as the distributed ledger ensures that the content cannot be altered without consensus from the network.

The smart electronic document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The smart electronic document can provide transparency to users by enabling them to verify the authenticity and integrity of the content at any time. This transparency is achieved through audit trails and visual indicators, ensuring that users can trust the document's reliability and security.

The access control instructions 108 manage who can access the data within the document 102. These instructions determine whether an entity is allowed to access the document 102 and control access based on predefined rules and permissions. By ensuring that only authorized users can interact with the document 102, the access control instructions 108, when executed, provide a secure environment for document management. The access control instructions 108 are essential for the document's capability to enable secure sharing and collaboration among multiple users with varying access levels. Further, these instructions, when executed, ensure that multiple authorized users may simultaneously access and revise one or more parts of the document 102 such that the revisions appear on respective users' interfaces of various devices associated with these users. The revisions themselves, however, are maintained on a single authoritative version of the document, namely the document 102.

The ownership instructions 110 are designed to maintain control over the document 102, even when shared with third parties. This interface enables the document's owner to manage ownership rights and control the distribution of the document 102. This feature is important for ensuring that the document's ownership is preserved and that the document 102 can be linked to a specific context in which the document 102 was shared. The ownership instructions 110 provide the document's owner with the ability to revoke access or grant temporary access as needed.

The in-document application instructions 112 are responsible for interoperability with a number of functionalities of the electronic document. For example, the in-document application instructions 112 integrate the underlying API 103 of the document 102 with various GUIs that are output as part of the electronic document. In some aspects, the in-document application instructions 112 may be interoperable with or access software instructions from one or more third-party software applications. However, the instructions of these third-party software applications may be embedded as part of the API 103 of the document 102 such that users are not required to leave the environment of the document 102 in order to use the in-document application. For example, users may utilize various functionalities of the in-document application while simultaneously being able to revise the electronic document 102, e.g., add or remove text, embed videos or images, and so forth.

The data storage 120 serves as an important component of the document 102, offering a secure location for storing data 122. The data storage 120 operates in conjunction with the storage instructions 106 to ensure that data is stored in an efficient and secure manner. The design of the data storage 120 maintains a single true copy of the document 102, ensuring consistency across all accessed instances and versions of the document 102.

The data 122 stored within the data storage 120 represents the content of the document 102. The data 122 is managed by the storage instructions 106 and is subject to the access control instructions 108, ownership instructions 110, and in-document application instructions 112. The data 122 serves as a central component of the document's functionality, providing the information that users interact with and manage through the document's interfaces.

The physical processor 130 is responsible for executing the instructions necessary for the operation of the document 102. The physical processor 130 handles updates to the document 102 and ensures that the document's functionalities are carried out efficiently. The physical processor 130 works in conjunction with the API 103 to execute the document's operations and manage the interactions of the document 102 with users and external systems. In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the components described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The application programming interface (API) 103 is a significant component of the document 102, providing a standardized interface for interaction between the document 102 and external systems or users. The API 103 enables a range of functionalities, including controlled access, modification, and management of the content of the document. It serves as a conduit for interaction, allowing the document 102 to integrate seamlessly with other software systems and support enhanced functionalities like automated workflows and data synchronization. The API 103 plays a crucial role in transforming the document 102 into an active, controllable entity that can interact with its environment in a secure and managed manner.

In the context of embodiments of this disclosure, the API embedded within the document serves as a pivotal component that transforms the document into a smart digital object. This API is not merely a set of protocols for building and interacting with software applications; it is an integral part of the document itself, enabling a wide array of functionalities that enhance the document's utility, security, and control.

The API provides a standardized interface that allows the document to interact seamlessly with external systems, applications, and users. This integration enables the document to function as part of a larger digital ecosystem, where it can communicate and exchange data with other software systems, such as cloud services, enterprise applications, and third-party tools. Through the API, the document's owner or controller can remotely manage the document's access and usage. This includes monitoring who accesses the document, tracking changes, and enforcing security protocols. The API allows for real-time updates and modifications, ensuring that the document remains current and relevant, regardless of its location or the number of copies in existence.

The API is equipped with robust security features, such as encryption and access control mechanisms, to protect the document from unauthorized access and tampering. It acts as a gatekeeper, ensuring that only authorized users can interact with the document. This level of security is essential for maintaining the integrity and confidentiality of the document's content. Additionally, the API enables dynamic content rendering, allowing the document to display the most current information and adapt its content based on user interactions or external data inputs. This capability is particularly useful for documents that require real-time updates, such as financial reports, legal documents, or collaborative projects.

By embedding the API within the document, embodiments of this disclosure support enhanced functionalities like automated workflows, data synchronization, and collaborative features. The API allows the document to function as an active, controllable entity that can interact with its environment in a secure and managed manner. Furthermore, the API ensures that the document is device and platform agnostic, meaning it can be accessed and interacted with from various types of devices and operating systems without compatibility issues. This flexibility helps ensure that the document can be used effectively in diverse digital environments.

In some aspects, the API serves as an immutable interface, providing a consistent and reliable framework for accessing and interacting with the document. This immutability ensures that the document's structure and access protocols remain stable over time, enhancing trust and reliability for users and applications interacting with the document. In summary, the API embedded within the document is a transformative component that elevates the document from a static file to a dynamic, interactive digital object. It provides the necessary infrastructure for secure, controlled, and flexible document management, addressing the challenges of traditional document handling and offering a comprehensive solution for modern digital environments.

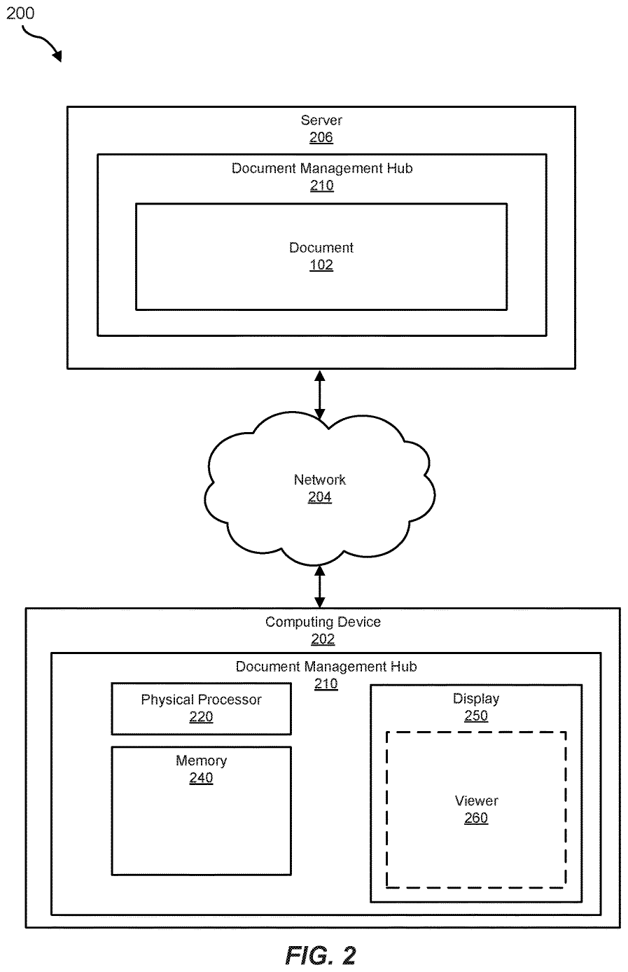

FIG. 2 illustrates a system 200 for managing electronic documents as smart digital objects. The system 200 comprises a computing device 202, a network 204, a server 206, a document 102, a document management hub 210 that can operate simultaneously in the server 206 and the computing device 202, a physical processor 220, a memory 240, and a viewer 260 that may be output on a display 250 communicatively coupled to the computing device 202.

The computing device 202 is a user-operated device that facilitates interaction with the system 200. The computing device 202 is operatively connected to the network 204 and includes the physical processor 220, the memory 240, and the viewer 260. The computing device 202 may be implemented as various types of devices, such as a mobile phone, tablet, desktop computing device, or laptop computing device. The physical processor 220 within the computing device 202 executes instructions to perform operations related to accessing and managing the document 102. The memory 240 stores data and instructions necessary for the operation of the computing device 202, including temporary and permanent storage of document-related information. The viewer 260 is responsible for rendering the content of the document 102 for presentation to the user, enabling functionalities such as real-time updates and collaborative editing.

The network 204 provides the communication pathway between the computing device 202 and the server 206. This pathway enables the transmission of requests, responses, and document content, while maintaining secure and efficient data exchange. The network 204 may be implemented using various communication technologies, including wired and wireless connections, and supports protocols such as TCP/IP and HTTP. The server 206 is a remote computing system that hosts the document 102. The server 206 is connected to the network 204 and interacts with the computing device 202 to process access requests and deliver the content of the document 102. The document 102 stored on the server 206 operates as a self-governing smart document capable of enforcing access permissions, tracking changes, and preserving the fidelity of the content within the document.

The document management hub 210 can comprise one or more machine readable instructions that are capable of being accessed and executed simultaneously by the processors of multiple devices, e.g., the computing device 202 and the server 206. While all of the machine readable instructions that comprise the document management hub 210 may be executable on multiple devices, not all devices may have access to all of the instructions that comprise the document management hub 210. The document management hub 210 comprises a set of instructions that control the generation and display of information. Further, the document management hub 210, in part, facilitates communication and sharing of information (1) between the electronic document 102 and instances of the electronic document 102 (e.g., user selectable hyperlinks, entry pages, and so forth), and (2) from one entry page to one or multiple entry pages.

The physical processor 220 within the computing device 202 executes operations related to the system 200, including processing access requests, rendering document content, and managing user interactions. This component facilitates the computing device 202 in performing tasks independently and with optimized performance. The memory 240 provides storage capabilities for the computing device 202, including the temporary caching of document data and the storage of instructions required for the operation of the viewer 260. This configuration enables the computing device 202 to access and manage the document 102 in an efficient manner.

The viewer 260 serves as the interface enabling the user to engage with the document 102. This component presents the content of the document 102 for display, facilitating actions such as viewing, editing, and collaboration. The viewer 260 accommodates real-time updates and maintains alignment between the displayed content and the version stored on the Server 206.

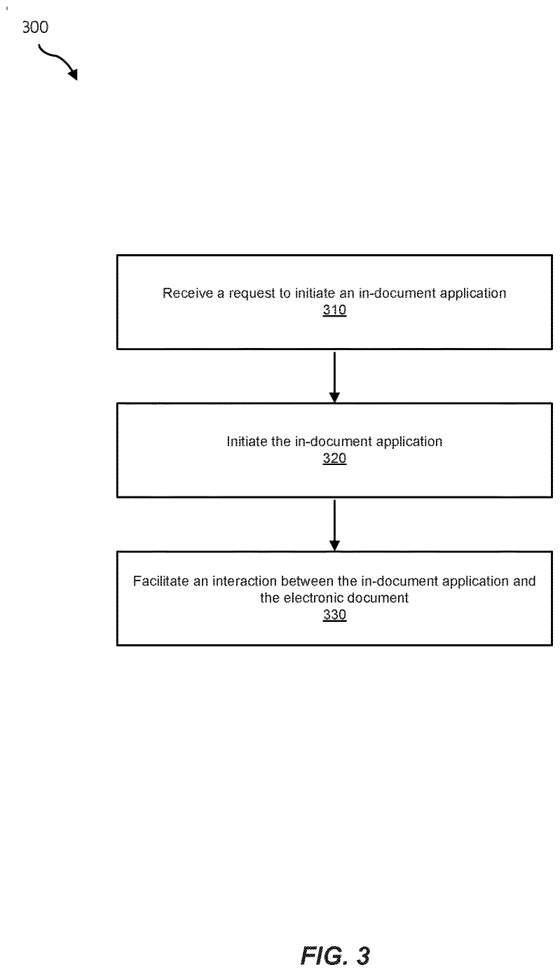

FIG. 3 illustrates a flowchart 300 of a method involving implementing an in-document application from within an environment of the document 102. The flowchart begins with step 310, wherein the electronic document 102 receives a request to initiate an in-document application. Then, at step 320, the electronic document 102 operating independently or in combination with document management hub 210, initiates the in-document application from an environment specific to the electronic document 102. The document 102 initiates the in-document application via execution of one or more instructions within the API 103, namely at least the in-document application instructions 112. Finally, step 330 involves facilitating, by the electronic document, an interaction between the in-document application and the electronic document.

At the outset, it is instructive to briefly revisit the concept of the document 102 as described herein. The document 102 acts as or is provisioned as digital infrastructure that integrates various interfaces and components to manage and update several capabilities and functionalities of the document. Specifically, the document 102 operates as a smart digital object capable of interacting with various aspects of other electronic documents, various types of digital content (e.g., embedded videos, images, etc.), and aspects of a filing framework specific to an entity, e.g., government, company, etc. In some aspects, the document 102 operates as digital infrastructure within the document management hub 210 and accesses, interacts with, and performs various actions using code, data, and metadata included as part of the document 102 and code, data, and metadata included in other electronic documents.

The document 102 performs these actions either independent of or while operating in combination with the document management hub 210. Further, the document 102 provisioned as digital infrastructure can include three layers of data, namely code, data, and metadata. Each of the code, data, and metadata are simultaneously, sequentially, or in some other way accessible and executable by (1) the document 102 itself and/or (2) other documents provisioned as digital infrastructure and authorized to access the document 102.

Code, as described herein, refers to instructions written in a programming language (Java, C++, Python, etc.) that can be executed by, e.g., the server 206, the computing device 202, or another device that accesses the electronic document 102. When executed, the code facilitates (1) the performing of computations specific to the document 102, (2) access to the electronic document 102 by other devices, (3) revising of the electronic document 102, (4) implementation of and access to one or more in-document applications within an environment of the electronic document 102, and (5) setting and updating of restrictions specific to the document 102. The code can be included as part of any of the set of instructions described above and shown in FIG. 1.

The data enhances the functionality, accessibility, and/or security of the document 102. This data can be stored directly within the document as embedded metadata, semantic tags, or encrypted content. This data and/or metadata associated with an electronic document may be stored in a single device or multiple devices. Additionally or alternatively, data can be accessible by the document 102 through various sources, such as linked databases or cloud storage systems, etc. The document 102 can dynamically retrieve and update information in real-time from various sources, e.g., financial reports, investment prospectuses, stock prices or various user interactions. Moreover, electronic documents provisioned as digital infrastructure can implement a number of access restrictions on themselves according to the preferences of the document owners. These restrictions can be updated approximately in real time as per the preferences of the document owners.

Additionally, data can be associated with the document 102 in other suitable ways, such as through audit trails, access logs, or related documents stored in a centralized system (e.g., the document management hub 210), providing a comprehensive view of the document's history and interactions. In some aspects, the APIs included as part of these documents provide a comprehensive view of a document interaction history to the owners. Indeed, in some examples, the term “electronic document” refers to any data, metadata, audit information, or intelligence that pertain to the electronic document. In other words, an electronic document may be made up of its data, metadata, intelligence, and/or other information. The data, metadata, intelligence, and/or other information of a document may be stored in any suitable manner (e.g., each of these items may be stored in a single database or device, distributed across multiple databases or devices, distributed across networked devices, etc.).

Data may be stored within or otherwise associated with an electronic document through execution of the electronic document on a computing device, a process that enables the document's function as a smart digital object. In some aspects, this process is not merely about saving data in a conventional sense but involves a sophisticated mechanism that ensures the document acts as a dynamic and interactive entity. As explained above, in some examples, the document is provisioned to maintain a single true copy, which facilitates ensuring consistency and integrity across all accessed versions. This single true copy can be stored in a secure environment, leveraging cloud-based infrastructure to facilitate accessibility and scalability.

Storing data within a document through execution of the document refers to the process where the document itself, as an active digital entity, manages and updates its own data content dynamically. This concept transforms the document from a static file into an interactive and intelligent object capable of executing operations to modify its content. In some examples, this involves including executable code or an API as part of the document, which allows it to perform actions such as data retrieval, processing, and storage autonomously.

For example, a document can be programmed to fetch the latest data from a remote server or database whenever it is opened, updating its content with real-time information such as current stock prices or weather forecasts. Another example is a collaborative document that tracks changes made by different users, storing these modifications within the document itself to maintain a comprehensive version history. This capability is particularly useful in environments where documents need to reflect the most current data or where user interactions need to be logged and managed directly within the document. By executing these operations internally, the document can ensure data consistency and integrity.

Finally, metadata refers to the underlying information descriptive of the data. For example, the metadata can be characteristics, context, or structure of the data such that if the data corresponds to an image file, the metadata can be the dimensions, resolution, date information of the image file, and so forth. In another example, if the data were a video, the metadata may correspond to the duration of the video, the video file size, etc. The code, data, and metadata are interoperable such that any or all of the code, data, or metadata of an electronic document 102 can be accessed and/or executed by the electronic document 102, the document management hub 210, or other documents provisioned as digital infrastructure.

Returning to FIG. 3, step 310 involves receiving, at the electronic document 102, a request to initiate an in-document application. Various types of entities may initiate such requests, e.g., employees, contractors, or collaborators, who would like to access an in-document application included as part of the document for work-related purposes. In some aspects, automated systems, such as software applications or services, may also require access to the in-document application for processing or integration purposes. For example, a data analysis tool can utilize one or more in-document applications in order to extract information from the document for reporting or analytics. External partners, including business partners, clients, or vendors, may also access various in-document applications during a collaborative project or transaction.

Returning to step 310, the electronic document 102 receiving a request to initiate an in-document application can include a user interacting with a user-selectable icon output on a portion of the document 102, e.g., an interface window output on a top portion of the document 102, which includes a number of user-selectable icons, drop-down menus, and so forth.

Step 320 involves the document 102 initiating, via execution of the electronic document 102, the in-document application. In aspects, initiation of the in-document application can involve the electronic document 102, via execution of at least the in-document application instructions 112, generating and outputting a GUI on a display. For example, the electronic document 102 may output a dialog box on the display 250 such that the user of the computing device 202, which is communicatively coupled to the display 250, may enter text, images, or other types of content therein. In another example, the electronic document 102 may, as part of the initiating, output a GUI that includes a number of users and one or more pending tasks associated with each respective user.

Step 330 involves the electronic document 102 facilitating an interaction between the in-document application and the document 102. Referencing the examples described above with respect to step 320, facilitating an interaction can include a user entering a number of questions into the dialog box and receiving a response directly from the electronic document 102, similar to a communication exchange that may occur between two individuals. Interaction facilitation can also include determining any pending tasks associated with a particular document such as a need for multiple authorized users to (1) sign the document or (2) review specific sections of the document 102.

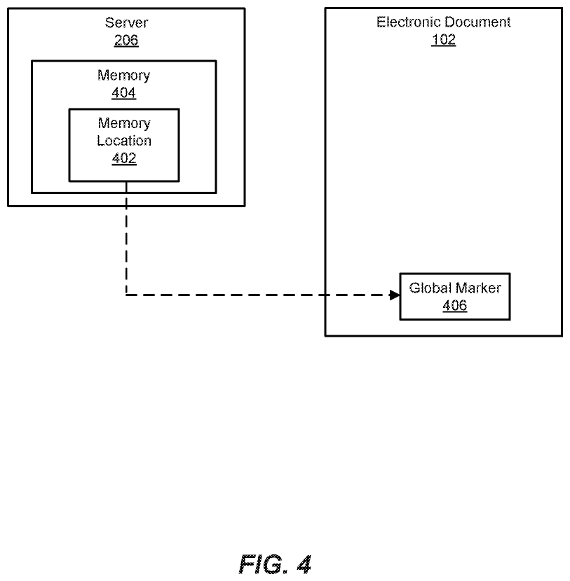

FIG. 4 illustrates the electronic document 102 as stored in a nonshared globally addressable location in memory of a device. Specifically, the electronic document 102—the sole authoritative version of the document 102—is stored in a unique and globally addressable location, e.g., in memory location 402 of memory 404 of the server 206. The memory location 402 is linked to the global marker 406 embedded in the electronic document 102, e.g., a hexadecimal character-based address (e.g., 019566cf-618e-7832-8332-9b7b14d16034). The global marker 406 is accessible by various authorized users via their respective devices. The global marker 406 can be a uniform resource locator (URL), universally unique identifier (UUID), or a globally unique identifier (GUID), or a set of alphanumeric characters based on some permutation or combination of one or more of these identifiers. When a user interacts with an in-document application to determine information about any pending tasks associated with the document, the in-document application accesses the code, data, and metadata of the document 102 stored in the memory location 402.

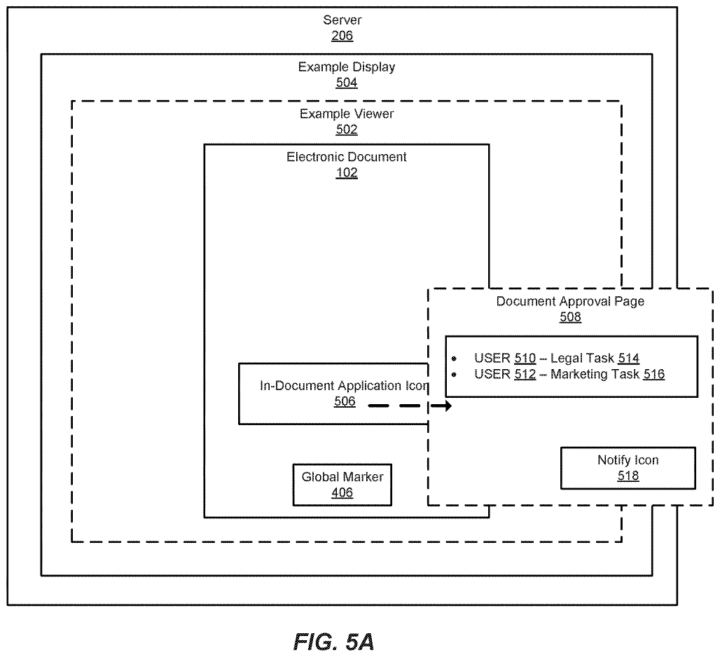

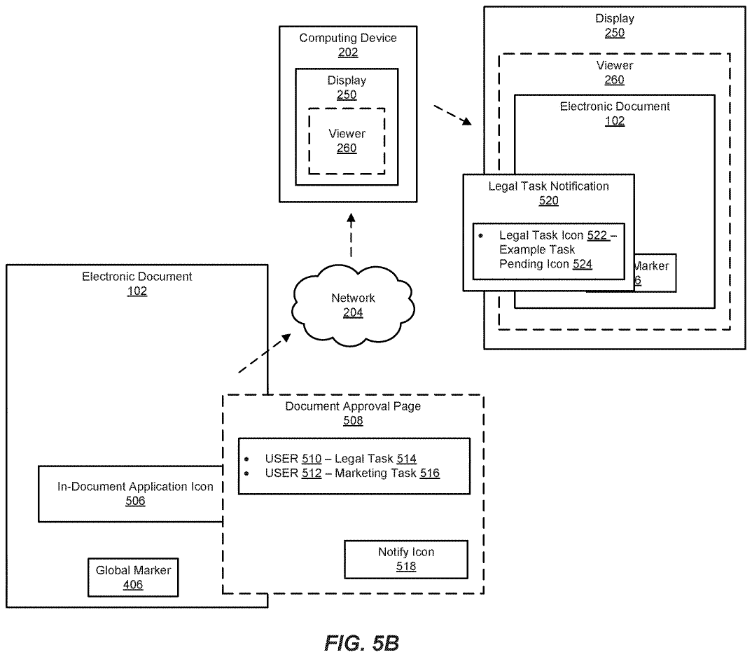

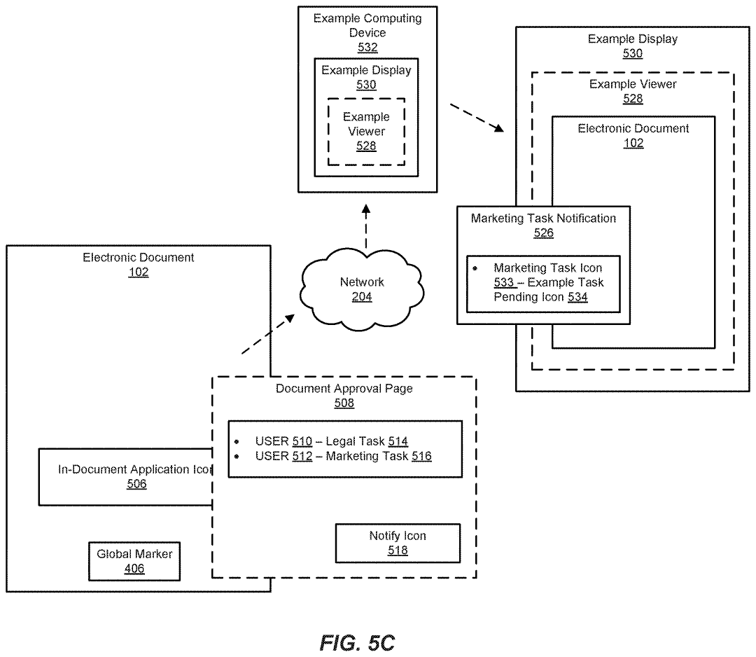

FIG. 5A illustrates an example use case of an owner of the document 102 initiating an in-document application for completing a document approval process specific to the document 102. For example, an owner of the document 102 may view the document 102 in example viewer 502 of example display 504 that is communicatively coupled to the server 206. Specifically, the owner—a General Counsel for a company—may select an in-document application icon 506 included on a portion of the electronic document 102 output on the example viewer 502 to initiate a document approval process. In response, the document 102 may, via execution of at least the in-document instructions 112, generate a document approval page 508 (e.g., a digital content box), which lists a number of users (e.g., user 510 and user 512) and a pending task associated with each respective user, e.g., a legal task 514 and a marketing task 516, respectively. Next, the owner may select a notify icon 518, responsive to which the electronic document 102 may notify each of the users 510 and 512 via, e.g., emails sent to the respective email addresses of the users 510 and 512, notifications output on displays coupled to the respective devices of the users 510 and 512, and so forth.

FIG. 5B illustrates the electronic document 102 displaying a legal task notification responsive to initiating a document approval process. For example, the notifications transmitted by the electronic documents may be output on the displays that are communicatively coupled to a plurality of devices external to the server 206. For example, the display 250 of the computing device 202—utilized by the user 510—may output a legal task notification 520 within a second or within fractions of a second after the electronic document 102 transmits the notifications (i.e. approximately in real time). In some aspects, the notification may be output on a portion of the display 250 overlaying digital content of the electronic document 102 that the user 510 may be viewing.

In some aspects, upon receipt of the legal task notification 520, the document management hub 210 may, via execution of at least the in-document application instructions 112, determine that the user 510 has a pending legal task that should be completed in relation to the electronic document 102. The document management hub 210 may, via execution of one or more instructions of the API 103, access the electronic document 102 and facilitate outputting of the electronic document 102, approximately simultaneously with the outputting of the legal task notification 520 on the display 250. For example, if the user 510 is interacting with an image that is separate and distinct from the electronic document 102, upon receipt of the legal task notification 520, the document management hub 210 may, automatically and without user intervention and approximately in real time, facilitate outputting the electronic document 102 over the image and the legal task notification 520 over a portion of the electronic document 102. In this way, the user 510 may immediately be notified of a pending legal task

The legal task notification 520 may include a legal task icon 522 and an example task pending icon 524. Selecting either of these icons may result in the electronic document 102 automatically scrolling to a page on which the legal task may need to be completed by the user 510. The legal task may include, e.g., reviewing a clause, responding to a legal query, analyzing a legal issue and including a comment on the document 102, and so forth.

The user 510 may complete the legal task by modifying content of the electronic document 102, e.g., adding a text to the electronic document 102, including a comment related to a clause in the document 102, etc. In response, the electronic document 102 may send a legal task completed notification to server 206. In this way, an in-document application enables the owner to efficiently oversee the completion of various tasks associated with a document without (1) generating multiple versions of an electronic document 102, (2) storing these versions in different memory locations, and (3) sharing versions with partial or contradictory information with different users.

FIG. 5C illustrates the electronic document 102 displaying a marketing task notification 526 responsive to initiating the document approval process as described above and illustrated in FIG. 5A. Similar to the outputting of the legal task notification 520 on the display 250, the document hub 210 may output a marketing task notification 526 on an example viewer 528 of an example display 530, which is communicatively coupled to an example computing device 532. In aspects, upon receipt of the marketing task notification 526, the document management hub 210 may, via execution of one or more instructions of the document management hub 210, execution of the in-document application instructions 112 of the document 102, or a combination thereof, determine that the user 512 has a pending marketing task that should be completed in relation to the electronic document 102.

The document management hub 210, via the computing device 202, accesses the electronic document 102 and facilitates outputting of the electronic document 102, approximately simultaneously with the outputting of a marketing task notification 526 on the display 250. In aspects, the document management hub 210 may overlay the marketing task notification 526 over a portion of the document 102 such that the user 512 is made aware of initiation of the document approval process. The marketing task notification 526 may include a marketing task icon 533 and an example task pending icon 534. Selecting either of these may result in the electronic document 102 scrolling to a page on which the marketing task may need to be completed by the user 512. The user 512 may complete the pending marketing task by modifying content of the electronic document 102.

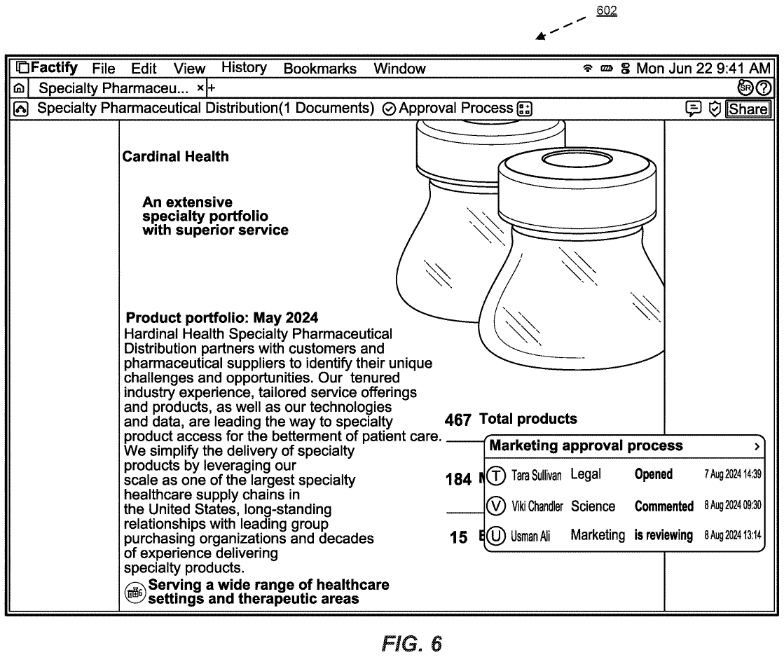

FIG. 6 illustrates an example digital content box that lists notifications of the completion of tasks completed by various users. An example electronic document 602 may initiate a document approval process specific to the document and transmit notifications to the devices of different users for completion of various pending tasks associated with document 602. Upon completion of various tasks, according to the steps described above with respect to FIGS. 5B and 5C, the document 602 may receive notifications that each of the tasks pending with respect to it, e.g., legal, science, and marketing tasks, have been completed. Consequently, the example electronic document 602 may generate a digital content box that (1) lists users associated with each of the legal, science, and marketing tasks (Tara, Viki, and Usman), and (2) lists a status identifier of “approved” next to each user. In other words, the example electronic document 602, upon receiving notifications that the pending tasks have been completed, may inform the initiator of the document approval process that the document has been completed.

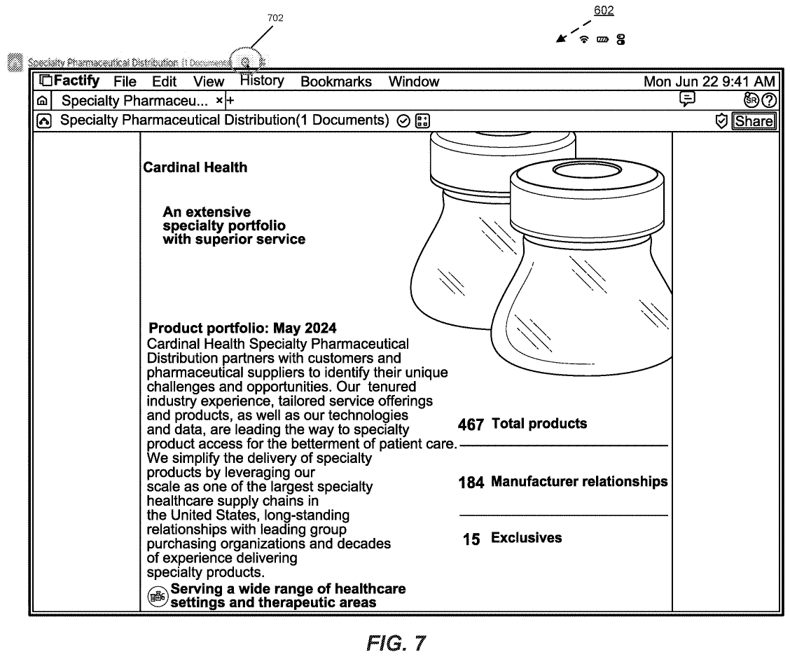

FIG. 7 illustrates a symbol of an in-document application representing completion of a document approval process. Specifically, upon completion of the document approval process, as described above and illustrated in FIG. 6, the example electronic document 602 may generate a symbol in the form of a check mark 702, automatically and without user intervention and approximately in real time. Alternatively or additionally, the example electronic document 602 may generate a number of other symbols to represent completion of the document approval process.

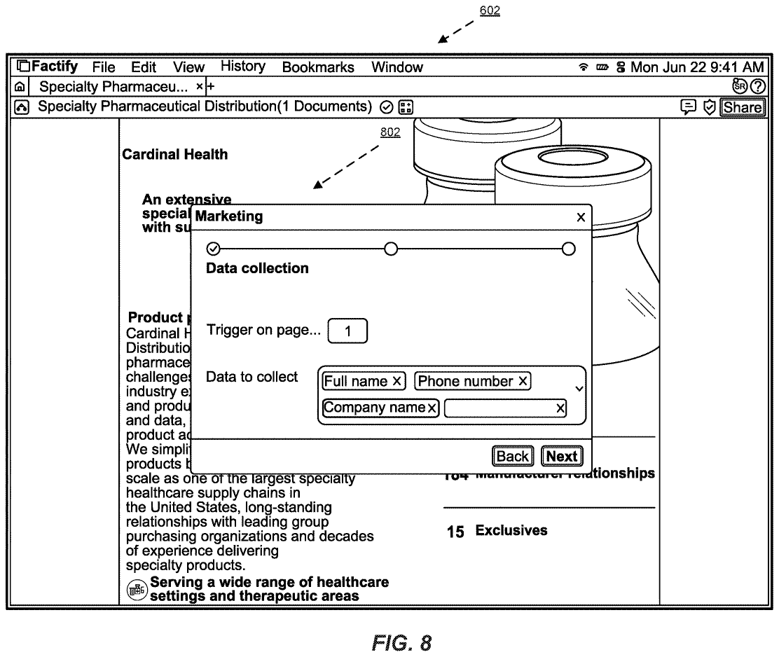

FIG. 8 illustrates the use of an interactive GUI 802 of an in-document application for distributing the example electronic document 602 to a number of users and obtaining data of the users' interaction with the document 602. In some aspects, prior to distributing the electronic document 602 to various users, e.g., via email or through the in-document application itself, the owner of the example electronic document 602 may set data collection rules, which are automatically implemented by the example electronic document 602 when a particular user opens the document and, e.g., scrolls through any part of page 1. In other words, scrolling through page 1 serves as a trigger, in response to which the example electronic document 602 obtains various types of information about the scrolling user, e.g., his or her full name, phone number, employer name, and so forth.

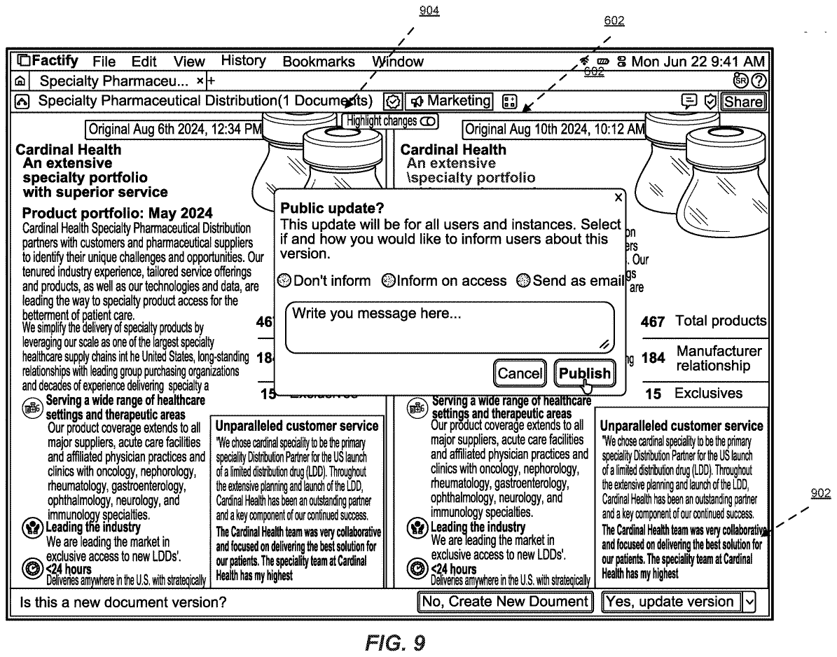

FIG. 9 illustrates modifying the example electronic document 602. For example, the owner may receive notifications of the completion of a document approval process specific to the example electronic document 602 and include one or more comments within the document 602. In aspects, the owner of the example electronic document 602 may want to determine the changes that were made to the document 602 as a result of the inclusion of his comments and any actions taken by various users during completion of the document approval process. As such, the owner can view the example electronic document 602 and an immediately preceding version of the document, e.g., preceding version 904, such that both versions are displayed adjacent to each other on a display. Thereafter, the owner may interact with a user selectable icon 902 labeled “Yes, update version” to finalize the changes to the example electronic document 602.

In aspects, another example of an in-document application can include a document access control framework, according to which an owner can control the extent of access a user has over a particular document. For example, upon completion of a document approval process, an owner of the document can utilize an in-document application to apply a tiered set of access rights such that a first user may be able to access any and all legal content but only partially access content related to marketing, while a second user may be able to access all marketing content but only partially view the legal content.

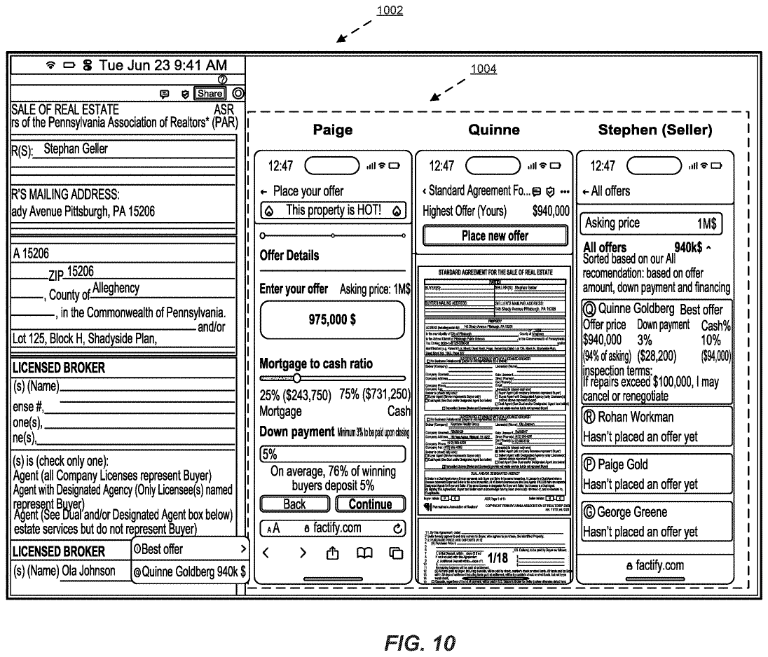

FIG. 10 illustrates a visual layout of an in-document application that includes multiple panels. For example, an owner of an example electronic document 1002 can view, as part of an in-document application, an interactive multi-panel GUI 1004, that enables the owner (e.g., Stephen) to interact simultaneously with different users, e.g., Page and Quinne in this instance. For example, the seller may choose to sell or auction his property to multiple potential purchasers and monitor the sale, approximately in real-time. As shown in FIG. 10, the seller—Stephen—may simultaneously view one or more actions performed by Page and Quinne (e.g., potential buyers) in the interactive multi-panel GUI 1004, and interact with these potential buyers from within the environment of the example electronic document 1002. Further, one of the panels may list the offer status of a number of other users, e.g., Rohan and George, in addition to listing the highest offer in the sale process.

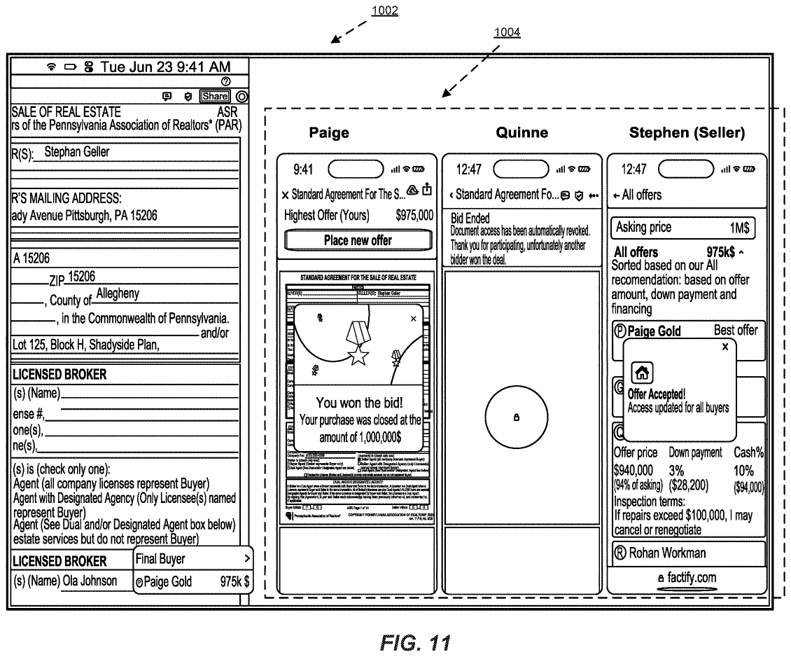

FIG. 11 illustrates another visual layout of the in-document application that also includes multiple panels. Specifically, FIG. 11 illustrates Stephen accepting a winning bid from Paige. It is noted that Stephen may complete the entire transaction using the in-document application and without exiting the environment of the example electronic document 1002.

In aspects, an example in-document application can provide users of an electronic document with a variety of different types of notifications. For example, the in-document application may enable an owner of an electronic document provisioned as digital infrastructure to transmit these documents to a number of different users and gather data about all of these users approximately in real time. The data can relate to which users have viewed the document, to whom these users may have forwarded the document, and so forth. Further, the owner can use the in-document application to disable users' access to the electronic document, e.g., approximately in real time. In some aspects, an in-document application may record various key events associated with an electronic document such as, e.g., a number of users that have signed the document, the various times at which the document was signed, and so forth. Such information may be displayed, approximately in real time, on a display of a device associated with an owner of the electronic document.

In some aspects, an in-document application can be an AI based application that is aware of a particular document that a user or owner is reviewing, in addition to cataloging various types and numbers of documents that the user has viewed and interacted with in the recent past, e.g., within the past one week, two weeks, one month, and so forth. The AI based in-document application may present a subset of these recently viewed documents on a display associated with a device of the user. The AI based in-document application may dynamically update, e.g., a home page of the document management hub 210 output on a display, based on the document interaction and access practices of the user.

The AI based in-document application may also track information about an environment (such as the weather, the season, the date, etc.) within a particular proximity of a user and present recommendations to the user via the in-document application based on this information. In particular, the AI based in-document application may predict a particular set of actions that a user is likely to take based on this information and facilitate completion of one or more of these actions. For example, based on this information, a particular in-document application may locate existing in-document applications to enable the user to perform various actions or even create new in-document applications to help the user complete various tasks.

In some aspects, another in-document application may operate such that the application, via execution of one or more of the instructions 112, tracks user interactions with an electronic document over a particular time frame and determines instances of deviation from a particular interaction pattern. For example, if a user is an attorney that typically accesses legal documents, but has recently accessed a number of financial documents on a regular basis for a predefined threshold time frame, e.g., opened twenty financial documents in the past week, the in-document application may identify this user behavior as a deviation from the user's standard document interaction pattern.

In some examples, the in-document application may monitor the location of the device that the user uses to access the financial documents and a time period during which these financial documents were accessed to determine a document access pattern specific to the user. For example, it may appear that the user accesses financial documents when he is at home and continues to access legal documents when he is at work. The in-document application may track these environmental variables and present a particular set of documents on a home page of a document management hub when the user is at home and another set of documents on the home page when the user is at work. In this way, the in-document application provides a customized experience to the user based on his interaction patterns and environmental factors specific to the user.

In some aspects, this in-document application analyzes other instances of the user's deviation from a standard document interaction pattern and identifies a particular document that a user may potentially interact with based on a new environment associated with the user. In other words, the in-document application may estimate when the user may deviate from a particular interaction pattern in a manner that is similar to when the user accessed financial documents at home. For example, if the user provides pro bono service to a charity, the in-document application may present files specific to the charity when the application determines that the user is at an office associated with the charitable organization, e.g., via analyzing a location of the user's device. Further, this in-document application tracks one or more instances of deviations from a user's normative document interaction pattern in view of the presence of, e.g., the user's supervisor. For example, the in-document application may determine, by tracking the supervisor's device within a proximity of the user's device, that, e.g., the user was reviewing an annual appraisal document. The in-document application may update its intelligence and prediction capability dynamically based on changes in the user's document interaction patterns.

In some aspects, a plurality of in-document applications may be rendered dynamically based on a user's document interaction history. For example, if a user accesses an in-document application that relates to a non-disclosure agreement and another in-document application that relates to a document approval process, these two in-document applications can be output prominently on a particular portion of the home page of the document management hub 210 for the user to view. In another example, if the user has to review and sign a legal document, the document management hub 210 may identify or dynamically generate an in-document application for providing the signature and include this application in a location adjacent to the two in-document applications that the user frequently accesses. In other words, the document management hub 210 may dynamically identify and/or generate one or more in-document applications customized for one or more tasks that a user may desire to perform.

Some embodiments involve a hub that uses artificial intelligence (AI) to dynamically create in-document applications and represent a significant advancement in digital document management, collaboration, and workflow automation. By integrating AI, the hub can analyze document content, user behavior, workflow requirements, and contextual data to generate tailored in-document applications—modular, embedded tools or interfaces that enhance the document's functionality and user experience.

One of the ways a hub can use AI to create in-document applications is by analyzing the semantic and structural content of documents. For example, when a contract is uploaded to the hub, AI algorithms can parse the document to identify key clauses, parties, deadlines, and signature blocks. Based on this analysis, the hub can automatically generate an in-document application for contract review and approval. This application might include features such as clause-by-clause commenting, automated risk assessment, and a signature workflow tailored to the identified parties. If the contract contains a renewal date, the AI can add a calendar integration or automated reminder application, ensuring stakeholders are notified in advance.

AI within the hub can also monitor user roles, access patterns, and historical interactions to create personalized in-document applications. For instance, if a user frequently reviews financial statements, the hub can generate a financial analysis application within those documents, providing tools for trend analysis, variance detection, and automated report generation. If another user is a compliance officer, the hub might embed a compliance checklist application that highlights regulatory requirements relevant to the document's content and tracks completion status. Over time, the AI can refine these applications based on observed user preferences, such as preferred data visualizations or workflow shortcuts, further enhancing productivity and user satisfaction.

The hub's AI capabilities can extend to workflow automation by dynamically generating in-document applications that manage tasks, approvals, and collaboration. For example, when a project proposal is created, the AI can embed a project management application within the document, allowing users to assign tasks, set deadlines, and track progress directly alongside the proposal content. If the document is a purchase order, the AI can generate an approval routing application that adapts to organizational hierarchies and spending thresholds, ensuring the document is automatically forwarded to the appropriate approvers. In legal settings, the AI can create an application for managing discovery requests, tracking which documents have been produced, reviewed, or withheld, and providing real-time status updates to all stakeholders.

AI-driven hubs can also create context-aware in-document applications that facilitate real-time collaboration. For example, during a virtual meeting where a document is being discussed, the AI can detect the presence of multiple users and generate a live annotation application, allowing participants to highlight text, add comments, and vote on proposed changes. If the document is a technical specification, the AI can embed a code review or bug tracking application, enabling engineers to log issues, suggest fixes, and link to relevant documentation-all within the document itself. In educational settings, the AI can generate quiz or feedback applications based on the content of study materials, allowing students to test their understanding and receive instant feedback.

A hub equipped with AI can further enhance in-document applications by integrating external data sources and systems. For example, in a marketing report, the AI can create a data visualization application that pulls real-time analytics from web traffic or social media platforms, embedding interactive charts and dashboards within the document. In supply chain management, the AI can generate a shipment tracking application that interfaces with logistics providers, displaying real-time status updates and estimated delivery times. For regulatory compliance, the AI can embed an application that cross-references document content with external legal databases, flagging potential compliance issues and suggesting corrective actions.

Security is another domain where AI-driven in-document applications can provide significant value. The hub can analyze document sensitivity, user roles, and access history to generate adaptive security applications. For instance, if a document contains confidential information, the AI can embed an access control application that enforces multi-factor authentication, tracks access attempts, and provides audit logs. If unusual access patterns are detected, the AI can dynamically adjust permissions or trigger alerts, ensuring that sensitive information remains protected.

In summary, a hub that uses artificial intelligence to dynamically create in-document applications transforms static documents into interactive, context-aware, and highly functional digital assets. By analyzing document content, user behavior, workflow requirements, and external data, the AI-powered hub can generate tailored applications that streamline collaboration, automate workflows, enhance security, and deliver personalized user experiences. Whether in legal, financial, healthcare, educational, or enterprise environments, this approach unlocks new levels of efficiency, compliance, and innovation, positioning smart electronic documents at the center of modern digital ecosystems.

Smart documents represent a groundbreaking evolution in the realm of digital document management, offering capabilities that transcend traditional static files. One of the transformative features of smart documents is their ability to present a user interface for in-document applications directly alongside the document itself. This eliminates the need for users to rely on external software or systems to interact with the document, creating a seamless and integrated experience. The user interface is designed to dynamically adapt to the context of the document and the user's role, ensuring that the tools and functionalities presented are relevant and intuitive. For example, when a user accesses a contract, the interface may display panels that highlight pending signatures, provide metadata about the document's history, or offer a timeline of interactions. These panels are not static; they are responsive to the document's lifecycle and the user's specific needs. If the contract is in the pre-signature stage, the interface may emphasize tools for reviewing clauses and adding comments. Once the contract is signed, the interface can shift to display options for sharing the document or tracking its distribution. This dynamic adaptability ensures that users are always presented with the most pertinent functionalities, streamlining workflows and enhancing productivity. By embedding the user interface directly within the document environment, smart documents eliminate the friction associated with switching between applications, allowing users to focus entirely on their tasks.

Another revolutionary aspect of smart documents is their ability to host in-document applications designed exclusively for use by AI agents or machines. These applications are tailored to perform complex computational tasks autonomously, leveraging the embedded intelligence of the document to interact with external systems and datasets. Unlike traditional documents, which require human intervention to process and analyze their content, smart documents can independently execute operations such as data validation, anomaly detection, and predictive modeling. For instance, an AI agent tasked with auditing financial records can access a smart document, extract relevant data, and verify compliance with regulatory standards without any human input. The document's embedded intelligence enables it to respond to machine-specific queries, negotiate communication protocols, and provide structured outputs in formats such as JSON or XML. This capability is particularly valuable in scenarios where speed and accuracy are critical, such as fraud detection or real-time analytics. By facilitating exclusive machine access, smart documents integrate seamlessly into broader AI ecosystems, supporting tasks that would be impractical or impossible for human users.

This machine-centric functionality not only enhances operational efficiency but also unlocks new possibilities for innovation, allowing organizations to leverage the full potential of artificial intelligence in their workflows. The practical applications of smart documents are exemplified by their use in a professional services firm. In some examples, a professional firm develops an in-document application specifically for verifying the validity of invoices in a particular jurisdiction. This application, embedded within the smart document framework, enables AI agents to analyze invoices for compliance with local regulations, flag discrepancies, and generate detailed reports. The application operates independently of the system of record, ensuring that its functionalities are tailored to specific use cases without altering the underlying document infrastructure.

For example, the application may access metadata about the invoice's origin, cross-reference it with regulatory databases, and provide a summary of its findings directly within the document interface. This separation of roles—where the application performs specialized tasks while the system of record maintains the integrity of the document—highlights the modularity and adaptability of smart documents. Furthermore, the application can dynamically adapt to changes in regulatory requirements, ensuring that its analyses remain accurate and relevant over time. By embedding such specialized applications within smart documents, PWC can streamline its auditing processes, reduce the risk of errors, and enhance the value it delivers to its clients. This example underscores the transformative potential of smart documents in professional services, demonstrating how they can be leveraged to address complex challenges and drive innovation in document management.

One aspect of smart documents is their ability to operate independently of a system of record while simultaneously hosting in-document applications that provide dynamic, context-aware functionalities. Unlike traditional documents, which are often tethered to external systems for storage, processing, and validation, smart documents are self-contained entities capable of executing complex operations autonomously. This independence is achieved through embedded intelligence, which allows the document to manage its lifecycle, interactions, and security without relying on external systems. In-document applications are defined as modular, embedded functionalities within the document itself, designed to perform specific tasks or provide particular services.

These applications are not external software programs but are integral components of the document, seamlessly integrated into its structure and accessible directly from the document's environment. For example, an in-document application may enable a user to initiate a contract approval process, track the progress of signatures, or analyze metadata associated with the document. The embedded nature of these applications ensures that users can perform these tasks without leaving the document's environment, creating a streamlined and efficient workflow.

Another feature of smart documents is their ability to adapt to workflows and provide personalized user experiences for every stakeholder involved in the document's lifecycle. In traditional systems, workflows are often rigid and require users to interact with external platforms or systems to complete tasks associated with a document. Smart documents, however, are designed to dynamically adapt to the context of the workflow and the specific needs of each stakeholder. This adaptability is achieved through embedded intelligence that analyzes the document's lifecycle, the roles of the stakeholders, and the tasks associated with the workflow. For instance, in a contract negotiation process, the document may present a legal reviewer with tools for analyzing clauses and suggesting edits, while simultaneously providing a marketing stakeholder with options for approving branding elements. Each stakeholder is exposed to a user experience tailored to their role and the current stage of the workflow. This personalization extends to the visual layout, functionalities, and notifications presented to the user, ensuring that the document serves as an intuitive and efficient tool for collaboration. The ability to provide personalized experiences is particularly valuable in complex workflows involving multiple stakeholders, as it reduces friction, enhances productivity, and ensures that each user has access to the tools and information they need to complete their tasks effectively.

Verification and audit capabilities are another aspect of smart documents, addressing longstanding challenges in ensuring the integrity, authenticity, and accuracy of document-related interactions. Traditional documents often rely on external systems or manual processes to verify their content, track changes, and audit interactions. These methods are not only inefficient but also prone to errors and vulnerabilities. Smart documents, on the other hand, are equipped with embedded intelligence that enables them to autonomously monitor, record, and verify events associated with their lifecycle. Verification in smart documents involves checking the accuracy and authenticity of various elements, such as signatures, content, and metadata. For example, when a user signs a document, the embedded intelligence can generate a digital signature using cryptographic techniques, ensuring that the signature is both tamper-proof and verifiable. The document can then store this signature alongside other metadata, creating a comprehensive audit trail that records every interaction with the document.

This audit trail is immutable and cryptographically secured, providing a reliable source of truth for verifying the document's history. In-document applications play a crucial role in facilitating verification and audit processes. These applications can analyze the document's metadata, cross-reference it with external databases, and provide insights into its provenance and interactions. For instance, an in-document application may verify that a contract was signed by the authorized parties, check that the content has not been altered since its creation, and confirm that the document complies with regulatory requirements. By embedding these capabilities directly within the document, smart documents eliminate the need for external systems and create a self-contained framework for ensuring integrity and compliance.

In summary, smart documents redefine the concept of digital document management by operating independently of systems of record, adapting to workflows to provide personalized user experiences, and embedding robust verification and audit capabilities. These innovations address longstanding challenges in document security, collaboration, and usability, creating a transformative paradigm that enhances efficiency, reduces risks, and unlocks new possibilities for innovation. By leveraging embedded intelligence and in-document applications, smart documents offer a comprehensive solution for modern digital environments, paving the way for a future where documents are not just static files but dynamic, interactive entities capable of managing their own lifecycle and interactions.

Another example feature of smart documents is their ability to host in-document applications that seamlessly integrate with a user interface within a centralized hub. This integration allows users to interact with the document in a dynamic and intuitive manner, eliminating the need for external software or systems. The user interface within the hub serves as a gateway to the document's embedded intelligence, providing tools and functionalities that are tailored to the specific needs of the user and the context of the document.

For example, when accessing a contract, the interface can display panels that highlight pending signatures, provide metadata about the document's history, or offer a timeline of interactions. These panels are not static; they are responsive to the document's lifecycle and the user's specific role. If the contract is in the pre-signature stage, the interface may emphasize tools for reviewing clauses and adding comments. Once the contract is signed, the interface can shift to display options for sharing the document or tracking its distribution. This dynamic adaptability ensures that users are always presented with the most pertinent functionalities, streamlining workflows and enhancing productivity. By embedding the user interface directly within the document environment, smart documents eliminate the friction associated with switching between applications, allowing users to focus entirely on their tasks.

Another capability of smart documents is the ability of in-document applications to create visual layers that render on top of the document itself. These visual layers can serve a variety of purposes, ranging from enhancing the user's understanding of the document to providing additional functionalities that augment the document's utility. For instance, an in-document application can generate a translation layer that renders the document's content in a different language, enabling seamless communication across linguistic barriers. Similarly, a spell-check layer can highlight grammatical errors and suggest corrections, ensuring the document's accuracy and professionalism. Highlighting tools may emphasize key sections of the document, such as clauses in a contract or critical data points in a financial report, making it easier for users to focus on the most relevant information. These visual layers can be subtle, such as underlining text or changing font colors, or more pronounced, such as overlaying annotations or graphical elements. The ability to render these layers directly within the document environment ensures that users can access these enhancements without leaving the document or relying on external tools. This integration not only improves the user experience but also ensures that the document remains a self-contained entity capable of adapting to the user's needs.

In-document applications also possess the ability to act on electronic documents in ways that mirror human interactions. Just as a user may add comments, signatures, or annotations to a document, these applications can perform similar actions autonomously. For example, an in-document application can analyze the document's content and add metadata that categorizes the document or provides contextual information about its usage. Another application can update the document's audit trail by recording interactions, such as access attempts or modifications, ensuring that the document's history is preserved and verifiable. These applications can also interact with external systems of record, adding new data or updating existing records based on the document's lifecycle. For instance, an application can automatically update a company's CRM system with data extracted from a sales contract, streamlining operations and reducing the risk of human error.

The ability of in-document applications to act on documents extends to modifying the document's content itself. For example, an application can revise a clause in a contract based on predefined rules or add a signature to a document after verifying the signer's identity. These actions are performed with the same level of precision and reliability as human interactions, ensuring that the document's integrity and authenticity are maintained. By enabling applications to act on documents, smart documents transform from static repositories of information into dynamic entities capable of managing their own lifecycle and interactions.

The integration of in-document applications within smart documents represents a paradigm shift in digital document management. By providing a user interface within a centralized hub, creating visual layers that enhance the document's utility, and enabling applications to act on documents autonomously, smart documents address longstanding challenges in document security, collaboration, and usability. These examples create a transformative framework that enhances efficiency, reduces risks, and unlocks new possibilities for innovation. As smart documents continue to evolve, they pave the way for a future where documents are not just static files but dynamic, interactive entities capable of adapting to their environment and serving the needs of their users.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker may be established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document can identify patterns in user interactions and recommend next steps, such as suggesting additional documents that may be relevant to the current task or flagging anomalies in the audit trail for review.

### How Intelligence is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-world Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In some examples, a smart electronic document includes three elements, at minimum—data (e.g., content, audit trail, other metadata, etc.), executable code (e.g., an API), and a globally unique marker.

Although illustrated as separate elements, the modules or components described and/or illustrated herein may represent portions of a single module or application or component. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

The following clauses show how aspects of this disclosure are technical solutions to technical problems and/or improve the functioning of a computing device.

Clause 1. A computer-implemented method comprising receiving, at an electronic document, a request to initiate an in-document application, initiating, by execution of the electronic document, the in-document application, and facilitating, by the execution of the electronic document, an interaction between the in-document application and the electronic document.

Clause 2. The computer-implemented method of clause 1, wherein the facilitating of the interaction comprising receiving, by the electronic document, an action associated with a document approval process specific to the electronic document, outputting on a display communicatively coupled to the computer, responsive to the action and by the execution of the electronic document, a digital content box overlaying a portion of the electronic document, selecting, via execution of the electronic document, a user selectable icon from the digital content box, and initiating responsive to the selection, via execution of the electronic document, the document approval process.

Clause 3. The computer-implemented method of clause 1 or clause 2, further comprising: communicating by the electronic document, responsive to the initiating, notifications to a plurality of devices external to the computer, the notifications including pending tasks associated with the document approval process specific to the electronic document.

Clause 4. The computer-implemented method of any of clauses 1-3, wherein each of the pending tasks is associated with a respective one or more of a plurality of users of the plurality of devices.

Clause 5. The computer-implemented method of any of clauses 1-3, wherein the digital content box overlaying a portion of the electronic document including the pending tasks and the respective one or more of a plurality of users associated with the pending tasks.

Clause 6. The computer-implemented method of any of clauses 1-5, further comprising: determining by the electronic document, based on the execution of the electronic document, whether the pending tasks have been completed, and generating by the electronic document, based on the execution of the electronic document and using the in-document application, a digital icon indicative of completion of the pending tasks responsive to determining that the pending tasks have been completed.

Clause 7. The computer-implemented method of any of clauses 1-6, wherein the facilitating of the interaction comprising: receiving, by the electronic document, an action associated with controlling access to the electronic document, outputting on a display communicatively coupled to the computer, responsive to the action and by the execution of the electronic document, a digital content box overlaying a portion of the electronic document, and selecting, via execution of the electronic document, an access control framework specific to the electronic document.

Clause 8. The computer-implemented method of any of clauses 1-7, further comprising applying, responsive to the selecting, the access control framework to the electronic document.

Clause 9. A system comprising: at least one physical processor and physical memory comprising computer-executable instructions that, when executed by the physical processor, cause the physical processor to receive, at an electronic document, a request to initiate an in-document application, initiate, by the execution of the electronic document, the in-document application, and facilitate, by the execution of the electronic document, an interaction between the in-document application and the electronic document.

Clause 10. The system of clause 9, wherein the computer-executable instructions, when executed by the physical processor, cause the physical processor to facilitate the interaction between the in-document application and the electronic document by receiving, by the electronic document, an action associated with a document approval process specific to the electronic document, outputting on a display communicatively coupled to the physical processor, responsive to the action and by the execution of the electronic document, a digital content box overlaying a portion of the electronic document, selecting, via execution of the electronic document, a user selectable icon from the digital content box, and initiating responsive to the selection, via execution of the electronic document, the document approval process.

Clause 11. The system of clause 9 or clause 10, wherein the computer-executable instructions, when executed by the physical processor, further cause the physical processor to: communicate, responsive to the initiating, notifications to a plurality of devices external to the physical processor, the notifications including pending tasks associated with the document approval process specific to the electronic document.

Clause 12. The system of any of clauses 9-11, wherein each of the pending tasks is associated with a respective one or more of a plurality of users of the plurality of devices.

Clause 13. The system of any of clauses 9-12, wherein the digital content box overlaying a portion of the electronic document including the pending tasks and the respective one or more of a plurality of users associated with the pending tasks.

Clause 14. The system of any of clauses 9-13, wherein the computer-executable instructions, when executed by the physical processor, further cause the physical processor to determine, based on the execution of the electronic document, whether the pending tasks have been completed, and generate, based on the execution of the electronic document and using the in-document application, a digital icon indicative of completion of the pending tasks responsive to determining that the pending tasks have been completed.

Clause 15. The system of any of clauses 9-14, wherein the computer-executable instructions, when executed by the physical processor, cause the physical processor to facilitate the interaction between the in-document application and the electronic document by receiving, by the electronic document, an action associated with controlling access to the electronic document, outputting on a display communicatively coupled to the physical processor, responsive to the action and by the execution of the electronic document, a digital content box overlaying a portion of the electronic document, and selecting, via execution of the electronic document, an access control framework specific to the electronic document.

Clause 16. The system of any of clauses 9-15, wherein the computer-executable instructions, when executed by the physical processor, further cause the physical processor to apply, responsive to the selecting, the access control framework to the electronic document.

Clause 17. A non-transitory computer-readable medium comprising one or more computer-executable instructions that, when executed by at least one processor of a computing device, cause the computing device to receive, at an electronic document, a request to initiate an in-document application, initiate, by the execution of the electronic document, the in-document application, and facilitate, by the execution of the electronic document, an interaction between the in-document application and the electronic document.

Clause 18. The non-transitory computer-readable medium of clause 17, wherein the one or more computer-executable instructions, when executed by at least one processor of the computing device, cause the computing device to facilitate the interaction between the in-document application and the electronic document by receiving, by the electronic document, an action associated with a document approval process specific to the electronic document, outputting on a display communicatively coupled to the computing device, responsive to the action and by the execution of the electronic document, a digital content box overlaying a portion of the electronic document, selecting, via execution of the electronic document, a user selectable icon from the digital content box and initiating responsive to the selection, via execution of the electronic document, the document approval process.

Clause 19. The non-transitory computer-readable medium of clause 17 or clause 18, wherein the one or more computer-executable instructions, when executed by at least one processor of the computing device, cause the computing device to communicate, responsive to the initiating, notifications to a plurality of devices external to the computing device, the notifications including pending tasks associated with the document approval process specific to the electronic document.

Clause 20. The non-transitory computer-readable medium of any of clauses 17-19, wherein each of the pending tasks is associated with a respective one or more of a plurality of users of the plurality of devices.

What is claimed is:

1. A computer-implemented method comprising:
receiving, at an electronic document, a request to initiate an in-document application, the electronic document comprising code configured to provide access to the in-document application within an environment of the electronic document;
initiating, by execution of the electronic document, the in-document application; and
facilitating, by the execution of the electronic document, an interaction between the in-document application and the electronic document.

2. The computer-implemented method of claim 1, wherein the facilitating of the interaction comprises:
receiving, by the electronic document, an action associated with a document approval process specific to the electronic document;
outputting on a display, responsive to the action and by the execution of the electronic document, a digital content box overlaying a portion of the electronic document;
selecting, via execution of the electronic document, a user selectable icon from the digital content box; and
initiating responsive to the selection, via execution of the electronic document, the document approval process.

3. The computer-implemented method of claim 2, further comprising:
communicating by the electronic document, responsive to the initiating, notifications to a plurality of devices, the notifications including pending tasks associated with the document approval process specific to the electronic document.

4. The computer-implemented method of claim 3, wherein each of the pending tasks is associated with a respective one or more of a plurality of users of the plurality of devices.

5. The computer-implemented method of claim 3, wherein the digital content box overlays a portion of the electronic document including the pending tasks and the respective one or more of a plurality of users associated with the pending tasks.

6. The computer-implemented method of claim 5, further comprising:
determining by the electronic document, based on the execution of the electronic document, whether the pending tasks have been completed; and
generating by the electronic document, based on the execution of the electronic document and using the in-document application, a digital icon indicative of completion of the pending tasks responsive to determining that the pending tasks have been completed.

7. The computer-implemented method of claim 1, wherein the facilitating of the interaction comprises:
receiving, by the electronic document, an action associated with controlling access to the electronic document;
outputting on a display, responsive to the action and by the execution of the electronic document, a digital content box overlaying a portion of the electronic document; and
selecting, via execution of the electronic document, an access control framework specific to the electronic document.

8. The computer-implemented method of claim 7, further comprising applying, responsive to the selecting, the access control framework to the electronic document.

9. The computer-implemented method of claim 1, further comprising generating a visual overlay layer, by the in-document application, and rendering the visual overlay layer on top of the electronic document.

10. The method of claim 1, wherein the electronic document is configured to host an in-document application that is configured for specific use by an artificial intelligence agent.

11. The method of claim 10, wherein the in-document application is configured to enable an artificial intelligence agent to verify validity of content of the electronic document.

12. The method of claim 1, wherein embedded intelligence of the electronic document is configured to provide one or more insights that inform artificial intelligence training.

13. The method of claim 1, wherein the electronic document is configured as a single source of truth in a manner that reduces artificial intelligence training bias caused by training on multiple copies of a traditional document.

14. A system comprising:
at least one physical processor; and
physical memory comprising computer-executable instructions that, when executed by the physical processor, cause the physical processor to:
receive, at an electronic document, a request to initiate an in-document application;
initiate, by the execution of the electronic document, the in-document application; and
facilitate, by the execution of the electronic document, an interaction between the in-document application and the electronic document.

15. The system of claim 14, wherein the computer-executable instructions, when executed by the physical processor, cause the physical processor to facilitate the interaction between the in-document application and the electronic document by:
receiving, by the electronic document, an action associated with a document approval process specific to the electronic document;
outputting on a display communicatively coupled to the physical processor, responsive to the action and by the execution of the electronic document, a digital content box overlaying a portion of the electronic document;
selecting, via execution of the electronic document, a user selectable icon from the digital content box; and
initiating responsive to the selection, via execution of the electronic document, the document approval process.

16. The system of claim 15, wherein the computer-executable instructions, when executed by the physical processor, further cause the physical processor to:
communicate, responsive to the initiating, notifications to a plurality of devices external to the physical processor, the notifications including pending tasks associated with the document approval process specific to the electronic document.

17. The system of claim 16, wherein each of the pending tasks is associated with a respective one or more of a plurality of users of the plurality of devices.

18. The system of claim 16, wherein the digital content box overlays a portion of the electronic document including the pending tasks and the respective one or more of a plurality of users associated with the pending tasks.

19. The system of claim 18, wherein the computer-executable instructions, when executed by the physical processor, further cause the physical processor to:
determine, based on the execution of the electronic document, whether the pending tasks have been completed; and
generate, based on the execution of the electronic document and using the in-document application, a digital icon indicative of completion of the pending tasks responsive to determining that the pending tasks have been completed.

20. The system of claim 14, wherein the computer-executable instructions, when executed by the physical processor, cause the physical processor to facilitate the interaction between the in-document application and the electronic document by:
receiving, by the electronic document, an action associated with controlling access to the electronic document;
outputting on a display communicatively coupled to the physical processor, responsive to the action and by the execution of the electronic document, a digital content box overlaying a portion of the electronic document; and
selecting, via execution of the electronic document, an access control framework specific to the electronic document.

21. The system of claim 20, wherein the computer-executable instructions, when executed by the physical processor, further cause the physical processor to:
apply, responsive to the selecting, the access control framework to the electronic document.

22. A non-transitory computer-readable medium comprising one or more computer-executable instructions that, when executed by at least one processor of a computing device, cause the computing device to:
receive, at an electronic document, a request to initiate an in-document application;
initiate, by the execution of the electronic document, the in-document application; and
facilitate, by the execution of the electronic document, an interaction between the in-document application and the electronic document.

23. The non-transitory computer-readable medium of claim 22, wherein the one or more computer-executable instructions, when executed by at least one processor of the computing device, cause the computing device to facilitate the interaction between the in-document application and the electronic document by:
receiving, by the electronic document, an action associated with a document approval process specific to the electronic document;
outputting on a display communicatively coupled to the computing device, responsive to the action and by the execution of the electronic document, a digital content box overlaying a portion of the electronic document;
selecting, via execution of the electronic document, a user selectable icon from the digital content box; and
initiating responsive to the selection, via execution of the electronic document, the document approval process.

24. The non-transitory computer-readable medium of claim 23, wherein the one or more computer-executable instructions, when executed by at least one processor of the computing device, cause the computing device to communicate, responsive to the initiating, notifications to a plurality of devices external to the computing device, the notifications including pending tasks associated with the document approval process specific to the electronic document.

25. The non-transitory computer-readable medium of claim 24, wherein each of the pending tasks is associated with a respective one or more of a plurality of users of the plurality of devices.
